(19) United States
(12) Patent Application Publication
(10) Pub. No.: US 2023/0241735 A1
(43) Pub. Date: Aug. 3, 2023

(54) DUST COLLECTOR FOR POWER TOOL

(71) Applicant: INGENIO TECHNOLOGY CO., LIMITED, Chai Wan (HK)

(72) Inventor: Wai Hang Raymond CHU, Chai Wan (HK)

(21) Appl. No.: 17/590,437

(22) Filed: Feb. 1, 2022

(51) Int. Cl. B23Q 11/00; B23B 45/02; B23B 47/34

(52) U.S. Cl. CPC B23Q 11/0046; B23Q 11/0071; B23B 45/02; B23B 47/34

(57) ABSTRACT

Dust collector for power tool, is installed on the position where the handle of the power tool installs and includes a dust suction opening which is set at the operation position of the power tool, an extraction device is provided for connecting with the dust suction opening to generate negative pressure to inhale the dust from the dust suction opening to a dust chamber. it can be easily installed to any power tool for collecting the dust during the operation of the power tool. Also, partial of the dust collector can act as a handle to stabilize the operation of the power tool.

### FIELD OF THE INVENTION

The present invention involves an accessory of the power tool, especially a duct collector.

### BACKGROUND OF THE INVENTION

Power tool, such as electric drill, are very popular tool for maintenance. But while power tool is operating, it will produce dust and it is potential hazard to human health. Therefore, power tool should be equipped with a device that can prevent dust from entering the environment, so that the operator will not be exposed to excessive dust when working. But the design of the dust collector on the market is dumb, for example it can only be installed to some kinds of power tool and poor versatility.

### SUMMARY OF THE PRESENT INVENTION

In view of the aforesaid drawbacks of the prior art, the present invention provides a dust collector for power tool, for much more easy installation and being adjustable during operation to adapt and collect dust.

So, the present invention provides: Dust collector for power tool, is installed on the position where the handle of the power tool installs and includes a dust suction opening which is set at the operation position of the power tool, an extraction device is provided for connecting with the dust suction opening to generate negative pressure to inhale the dust from the dust suction opening to a dust chamber.

Further, the dust chamber is connected with the extraction device by a scalable pipeline, and the dust suction opening and the dust chamber slide along with the scalable pipeline; a spring is provided to push the dust suction opening against the operation surface.

Further, the dust suction opening is a sleeve which can be passed through by a drill; a suction port is arranged around the inner wall of the sleeve and a cover sheet is set to cover the hole of the sleeve on the side which the dill enters.

Further, a passage is provided between the sleeve and the dust chamber.

Further, the scalable pipeline is installed in a extraction assembly, which includes the extraction device, a protection shell and a battery supply; the scalable pipeline is embedded in the protection shell, the protection shell is fixed to the power tool and the battery supply is protrude downward as an operation handle of the power tool.

The present invention has the following advantages: The dust collector is mounted on the position where the handle of the power tool installs. So it can be easily installed to any power tool for collecting the dust during the operation of the power tool. Also, partial of the dust collector can act as a handle to stabilize the operation of the power tool.

### BRIEF DESCRIPTION OF THE DRAWINGS

Below are explanations of the invention combining with drawings.

FIG. 1 is the front view of the present invention.

FIG. 2 is the explosive view of the dust collector.

FIG. 3 is the perspective view of the sleeve.

In the figures: 1. the dust suction opening, 2. the extraction device, 3. the dust chamber, 4. the scalable pipeline, 5 .the suction port, 6. the cover sheet, 7. the passage, 8. the protection shell, 9. the battery supply.

### DESCRIPTION OF THE EMBODIMENTS

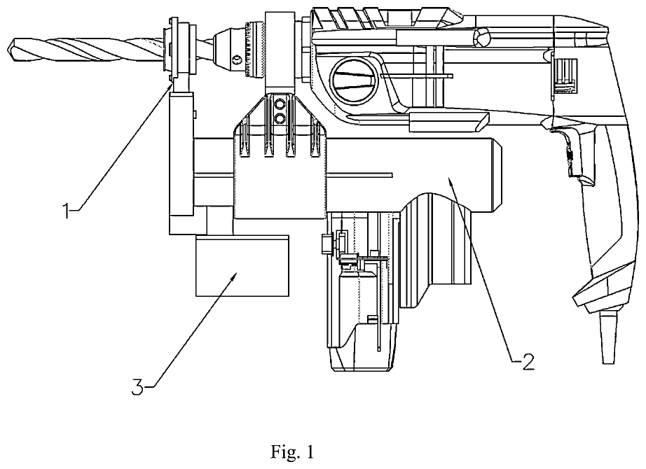

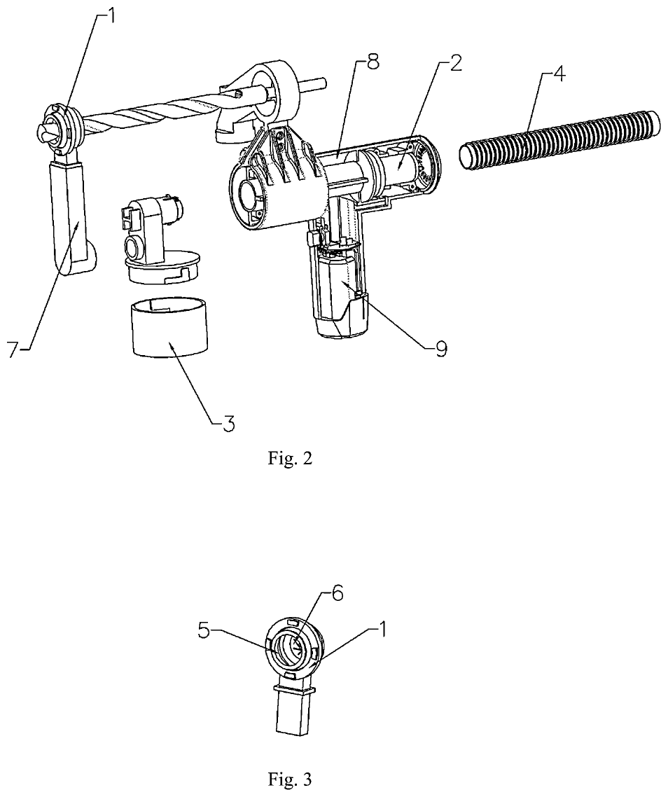

Refer to FIG. 1 and FIG. 2, the dust collector for power tool is installed on the position where the handle of the power tool installs. So it can be easily installed to any power tool for collecting the dust during the operation of the power tool. When power tool is under operation, usually using a handle is very necessary to stabilize the power tool. When it is necessary, user can hold partial of the dust collector can act as a handle.

The dust collector at least includes a dust suction opening 1, an extraction device 2 and a dust chamber 3. The dust suction opening 1 is mounted at the operation position of the power tool. Generally for the electric drill, the dust suction opening 1 is a sleeve which can be passed through by the drill. The extraction device 2 is a negative pressure generator which is driven by a motor. According to user's operation, the motor starts to generate negative pressure to inhale the dust from the dust suction opening 1 to the dust chamber 3.

The dust chamber 3 can be detachable from the dust collector for easily emptying the dust chamber 3. During the operation of the electric drill, the dust suction opening 1 must keep push against the operation surface to avoid leakage. So the dust suction opening 1 and the dust chamber 3 slide along the operation direction and a spring is provided to push the dust suction opening 1 against the operation surface. To keep the connection between the dust chamber 3 and the extraction device 2, a scalable pipeline 4 is provided, while the dust suction opening 1 and the dust chamber 3 slide.

Moreover, the sleeve provides a suction port 5 which is arranged around the inner wall of the sleeve, refer to FIG. 3. While drilling, most of the dust can just go into the sleeve then is inhaled by the suction port 5. Also, there is a cover sheet 6 which is set to cover the hole of the sleeve on the side which the dill enters to prevent the dust pass through and let the air intake mainly from the side against the operation surface for inhaling the dust.

Between the sleeve and the dust chamber 3, a passage 7 is provided for the inhaled dust being transported.

Further, the extraction assembly is provide, which includes the extraction device 2, a protection shell 8 and a battery supply 9. The protection shell 8 is mainly for the installation of all the parts, such as the spring, the scalable pipeline 4, the motor and the battery supply 9. It is fixed to the position where the handle of the power tool installs and the partial of where the battery supply 9 installs protrudes downward as an operation handle of the power tool. So user can hold the battery supply 9 part as a handle to stabilize the power tool during operation.

1. Dust collector for power tool, wherein is installed on the position where the handle of the power tool installs and includes a dust suction opening (1) which is set at the operation position of the power tool, an extraction device (2) is provided for connecting with the dust suction opening (1) to generate negative pressure to inhale the dust from the dust suction opening (1) to a dust chamber (3).

2. The dust collector for power tool of claim 1, wherein the dust chamber (3) is connected with the extraction device (2) by a scalable pipeline (4), and the dust suction opening (1) connects to the dust chamber (3); the dust suction opening (1) and the dust chamber (3) slide along with the scalable pipeline (4); a spring is provided to push the dust suction opening (1) against the operation surface.

3. The dust collector for power tool of claim 1, wherein the dust suction opening (1) is a sleeve which can be passed through by a drill; a suction port (5) is arranged around the inner wall of the sleeve and a cover sheet (6) is set to cover the hole of the sleeve on the side which the dill enters.

4. The dust collector for power tool of claim 3, wherein a passage (7) is provided between the sleeve and the dust chamber (3).

5. The dust collector for power tool of claim 2, wherein the scalable pipeline (4) is installed in a extraction assembly, which includes the extraction device (2), a protection shell (8), and a battery supply (9);
the scalable pipeline (4) is embedded in the protection shell (8), the protection shell (8) is fixed to the power tool and the battery supply (9) is protrude downward as an operation handle of the power tool.
